(19) United States
(12) Patent Application Publication
(10) Pub. No.: US 2026/0156225 A1
(43) Pub. Date: Jun. 4, 2026

(54) SYSTEMS AND METHODS FOR COLOR TRANSFORMATION VIA DOCUMENT SPECIFIC ABSTRACT PROFILES

(71) Applicant: Juan Martorell Climent, Blue Springs, MO (US)

(72) Inventor: Juan Martorell Climent, Blue Springs, MO (US)

(21) Appl. No.: 18/932,626

(22) Filed: Oct. 31, 2024

(51) Int. Cl. H04N 1/64; H04N 1/60

(52) U.S. Cl. CPC H04N 1/644; H04N 1/603

(57) ABSTRACT

Methods, systems and computer readable media for color transformation via document specific abstract profiles are described. For example, the method can include obtaining an input image file having one or more colors in a first color space, inspecting colors in the input image file to obtain colors in a second color space, and receiving selection of a first source color in the second color space based on a pixel location in the input image file. The method can also include receiving a selection of a first source radius in the input image file, receiving a first target color in the second color space, determining a color transformation function from the first source color to the first target color in the second color space, and generating an abstract profile specific to the input image file.

### TECHNICAL FIELD

Embodiments relate generally to digital color processing, and more particularly, to methods, systems and computer readable media for color transformation via document specific abstract profiles.

### BACKGROUND

Conventional digital color processing often includes a color management system and separate RIP software to interface with an output device such as a printer. One challenge in color processing is trying to match a given target color from a source color in a document.

Conventional techniques for color matching or color adjustment may suffer from one or more limitations or problems. For example, some conventional techniques may require the source document to be edited within a graphical editing program such as PhotoShop™ by Adobe™. In another example, general purpose abstract profiles are available, but the conventional abstract profiles may not be document specific (e.g., may transform a color document to black and white, etc.).

A need may exist for a color transformation or correction method and system that does not require graphical image editing software and that is document specific.

Some implementations were conceived in light of the above-mentioned needs, problems and/or limitations, among other things.

### SUMMARY

Some implementations can include a method. The method can include obtaining an input image file having one or more colors in a first color space, inspecting colors in the input image file to obtain colors in a second color space, and receiving selection of a first source color in the second color space based on a pixel location in the input image file. The method can also include receiving a selection of a first source radius in the input image file, wherein the source radius is determined based on the pixel location of the first source color selection, receiving a first target color in the second color space, and determining a color transformation function from the first source color to the first target color in the second color space.

The method can further include generating an abstract profile specific to the input image file, wherein the abstract profile includes a color transformation from the first source color to the target color generated by applying the color transformation function and from any additional source colors within the first source radius to respective transformed colors by applying the transformation function to the additional source colors respectively, and generating an output image file by applying the abstract profile to the input image file to obtain an output image file having transformed colors, wherein the output image file is generated solely with the abstract profile specific to the input image file and without performing an image editing operation on the input image file.

The method can also include receiving an output color from an output device as the target color, and determining a machine deviation transformation function based on the source color and the output color, wherein generating the abstract profile further includes applying the machine deviation transformation function to the input color in addition to the color transformation function such that the source color and any additional source colors are transformed by applying both the color transformation function and the machine deviation transformation function.

The method can also include receiving selection of one or more subsequent source colors and corresponding radii and generating corresponding color transformation functions for each of the one or more subsequent colors and corresponding additional subsequent colors within the corresponding radius. The method can further include receiving one or more subsequent target colors each corresponding to one of the one or more subsequent source colors and determining one or more subsequent color transformation functions for each of the one or more subsequent source colors, wherein generating the abstract profile includes one or more subsequent color transformations based on the one or more subsequent color transformation functions.

The method can also include generating printer instructions by applying the abstract profile to the input image file to obtain an output image having transformed colors and being configured to send directly to a printer. In some implementations, the first color space is an Lab color space and the second color space is an Lab color space. In some implementations, the second color space is an Lab color space and the first color space is a color space different than Lab.

### BRIEF DESCRIPTION OF THE DRAWINGS

FIG. 1 shows a block diagram of an example network environment in accordance with some implementations.

FIG. 2 is a diagram showing process components for a color transformation via document specific abstract profile in accordance with some implementations.

FIG. 3 is a diagram showing example tasks using color transformation via document specific abstract profile in accordance with some implementations.

FIG. 4 is a flowchart showing an example color transformation via document specific abstract profile process in accordance with some implementations.

FIG. 5 is a diagram of a single point color transformation in accordance with some implementations.

FIG. 6 is a diagram showing a single point with radius color transformation in accordance with some implementations.

FIG. 7 is a diagram showing a single point with radius color transformation coupled with a machine deviation correction function in accordance with some implementations.

FIG. 8 is a diagram of an example computing device configured for electronic employment document control in accordance with at least one implementation.

### DETAILED DESCRIPTION

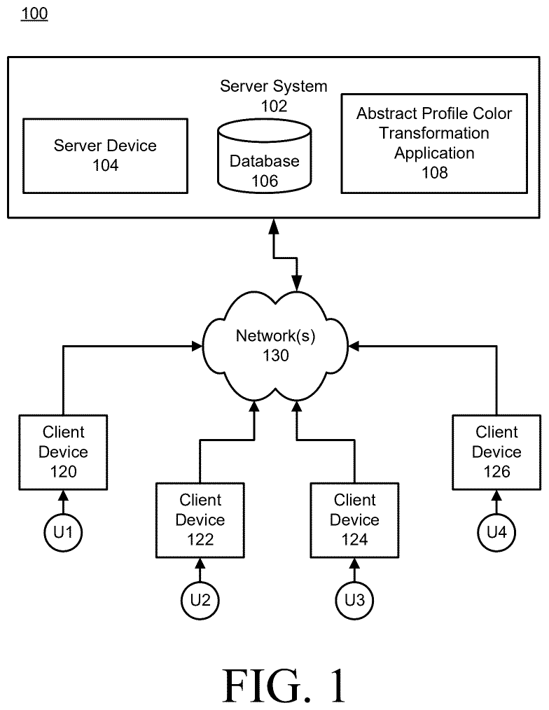

FIG. 1 illustrates a block diagram of an example network environment 100, which may be used in some implementations described herein. In some implementations, network environment 100 includes one or more server systems, e.g., server system 102 in the example of FIG. 1. Server system 102 can communicate with a network 130, for example. Server system 102 can include a server device 104, a database 106 or other data store or data storage device, and an application 108 for color transformation via document specific abstract profiles. Network environment 100 also can include one or more client devices, e.g., client devices 120, 122, 124, and 126, which may communicate with each other and/or with server system 102 via network 130. Network 130 can be any type of communication network, including one or more of the Internet, local area networks (LAN), wireless networks, switch or hub connections, etc. In some implementations, network 130 can include peer-to-peer communication 132 between devices, e.g., using peer-to-peer wireless protocols.

For ease of illustration, FIG. 1 shows one block for server system 102, server device 104, and database 106, and shows four blocks for client devices 120, 122, 124, and 126. Some blocks (e.g., 102, 104, and 106) may represent multiple systems, server devices, and network databases, and the blocks can be provided in different configurations than shown. For example, server system 102 can represent multiple server systems that can communicate with other server systems via the network 130. In some examples, database 106 and/or other storage devices can be provided in server system block(s) that are separate from server device 104 and can communicate with server device 104 and other server systems via network 130. Also, there may be any number of client devices. Each client device can be any type of electronic device, e.g., desktop computer, laptop computer, portable or mobile device, camera, cell phone, smart phone, tablet computer, television, TV set top box or entertainment device, wearable devices (e.g., display glasses or goggles, head-mounted display (HMD), wristwatch, headset, armband, jewelry, etc.), virtual reality (VR) and/or augmented reality (AR) enabled devices, personal digital assistant (PDA), media player, game device, etc. Some client devices may also have a local database similar to database 106 or other storage. In other implementations, network environment 100 may not have all of the components shown and/or may have other elements including other types of elements instead of, or in addition to, those described herein.

In various implementations, end-users U1, U2, U3, and U4 may communicate with server system 102 and/or each other using respective client devices 120, 122, 124, and 126. In some examples, users U1, U2, U3, and U4 may interact with each other via applications running on respective client devices and/or server system 102, and/or via a network service, e.g., an image sharing service, a messaging service, a social network service or other type of network service, implemented on server system 102. For example, respective client devices 120, 122, 124, and 126 may communicate data to and from one or more server systems (e.g., server system 102). In some implementations, the server system 102 may provide appropriate data to the client devices such that each client device can receive communicated content or shared content uploaded to the server system 102 and/or network service. In some examples, the users can interact via audio or video conferencing, audio, video, text chat, or other communication modes or applications. In some examples, the network service can include any system allowing users to perform a variety of communications, form links and associations, upload and post shared content such as images, image compositions (e.g., albums that include one or more images, image collages, videos, etc.), audio data, and other types of content, receive various forms of data, and/or perform socially-related functions. For example, the network service can allow a user to send messages to particular or multiple other users, form social links in the form of associations to other users within the network service, group other users in user lists, friends lists, or other user groups, post or send content including text, images, image compositions, audio sequences or recordings, or other types of content for access by designated sets of users of the network service, participate in live video, audio, and/or text videoconferences or chat with other users of the service, etc. In some implementations, a “user” can include one or more programs or virtual entities, as well as persons that interface with the system or network.

A user interface can enable display of images, image compositions, data, and other content as well as communications, privacy settings, notifications, and other data on client devices 120, 122, 124, and 126 (or alternatively on server system 102). Such an interface can be displayed using software on the client device, software on the server device, and/or a combination of client software and server software executing on server device 104, e.g., application software or client software in communication with server system 102. The user interface can be displayed by a display device of a client device or server device, e.g., a display screen, projector, etc. In some implementations, application programs running on a server system can communicate with a client device to receive user input at the client device and to output data such as visual data, audio data, etc. at the client device.

In some implementations, server system 102 and/or one or more client devices 120-126 can provide color transformation via document specific abstract profiles functions as described herein.

Various implementations of features described herein can use any type of system and/or service. Any type of electronic device can make use of the features described herein. Some implementations can provide one or more features described herein on client or server devices disconnected from or intermittently connected to computer networks.

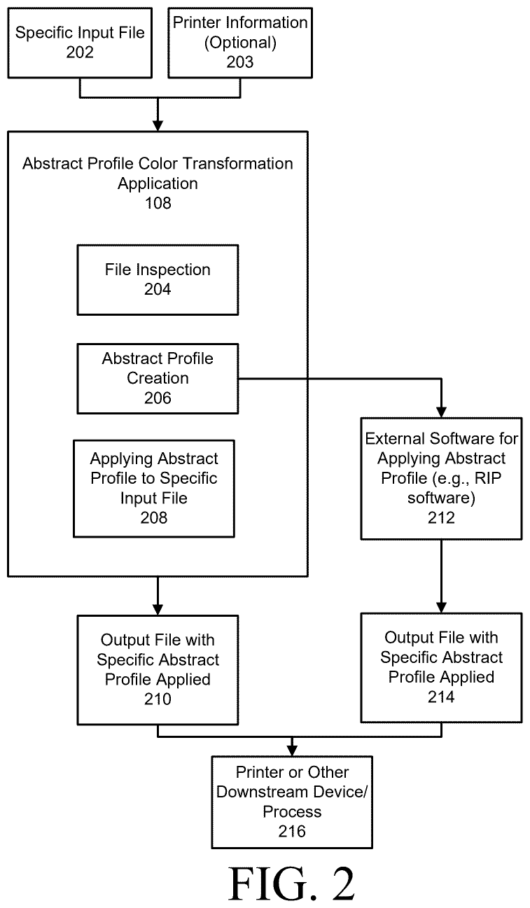

FIG. 2 is a diagram showing process components for a color transformation via document specific abstract profile in accordance with some implementations. In particular, FIG. 2 shows a specific input image file (e.g., a PDF document) and optional printer (or other output device) information 203 provided as input to the abstract profile color transformation application 108. The abstract profile color transformation application 108 includes a file inspection module 204, an abstract profile creation module 206 and a module to apply the abstract profile to the input file 208.

The abstract profile color transformation application 108 can apply the document specific abstract profile to the specific input file 202 to output a file comprised of the specific input file with the abstract profile generated specifically for the input file 202 applied (210). Alternatively, the abstract profile color transformation application 108 can provide document specific abstract profile to an external software system (e.g., RIP software), which can, in turn, output a file with the specific abstract profile applied to the input file. The output files (210 or 214) can be sent to a printer or other downstream device or process 216.

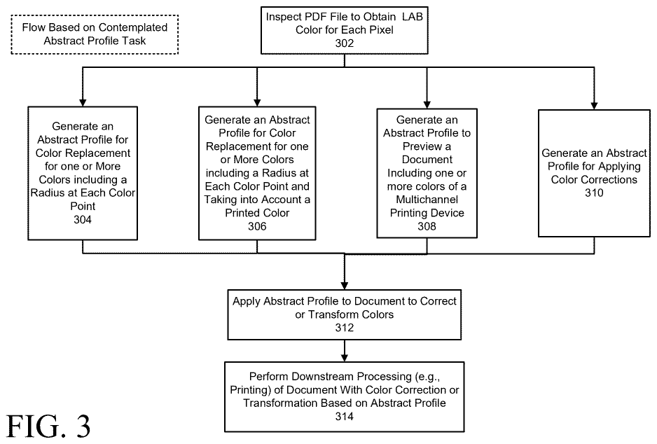

FIG. 3 is a diagram showing example tasks using color transformation via document specific abstract profile in accordance with some implementations. As shown in FIG. 3, the document specific abstract profile system can be used for various tasks. For example, an input image file such as a PDF file can be inspected to obtain an Lab color for each pixel in the document 302. Once Lab colors are obtained for the input document, the abstract profile color transformation application can be used to generate a document specific abstract profile for color replacement for one or more colors including a radius at each color point 304.

In another example, the abstract profile color transformation application can generate an abstract profile for color replacement of one or more colors including a radius at each color point and taking into account a printed color that provides a machine deviation 306.

In another example, the abstract profile color transformation application can generate a preview of a document with one or more color transformations for a multichannel printing device 308.

In another example, the abstract profile color transformation application can generate a document specific abstract profile for applying one or more color corrections 310.

The output of 304-310 can be applied to the input image file to correct or transform colors as utilized for 304-310. At 314, downstream processing (e.g., printing) of the input file is performed with the document specific abstract profile applied.

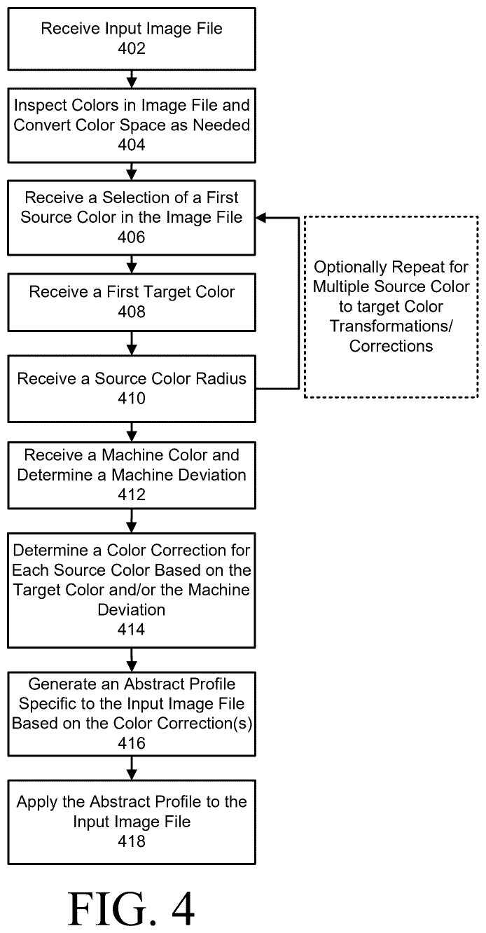

FIG. 4 is a flowchart showing an example color transformation via document specific abstract profile process in accordance with some implementations. Processing begins at 402, where an input image file is received. The input image file can include a PDF document or any other suitable image file type. Processing continues to 404.

At 404, the colors in the image file are inspected to determine an Lab color for each pixel (or pixels in a specific section) in the document. Optionally, the color space of the document is converted from a first color space (e.g., RGB, CYK, or other color space) to a second color space (e.g., Lab), as needed. In some implementations, the input document is in Lab color space and the colors can be used directly. Processing continues to 406.

At 406, a selection of a first source color is received. For example, the first source color selection can include a selected pixel within the input image or color inspected and/or converted representation of the input image. Processing continues to 408.

At 408, a first target color is received. For example, the first target color can be selected from a color palette graphical user interface, can be entered directly, can be selected from a color in the source image or other image, can be a color scanned or measured in an output product (e.g., a printed paper, fabric or other material), etc. In general, any suitable method for selecting or inputting a target color can be used. Processing continues to 410.

At 410, a source color radius is received. The radius can range from 0 to a value within the extent of the input image dimensions. A radius greater than zero incorporates any colors within the input radius about the source color pixel as input colors. Processing continues to 412.

It will be appreciated that 406-408 can be repeated for additional source input colors and corresponding radii.

At 412, a machine color is optionally received. The machine color (e.g., a measured output color on a printed document, fabric, etc.) can be used to determine a machine deviation. Processing continues to 414.

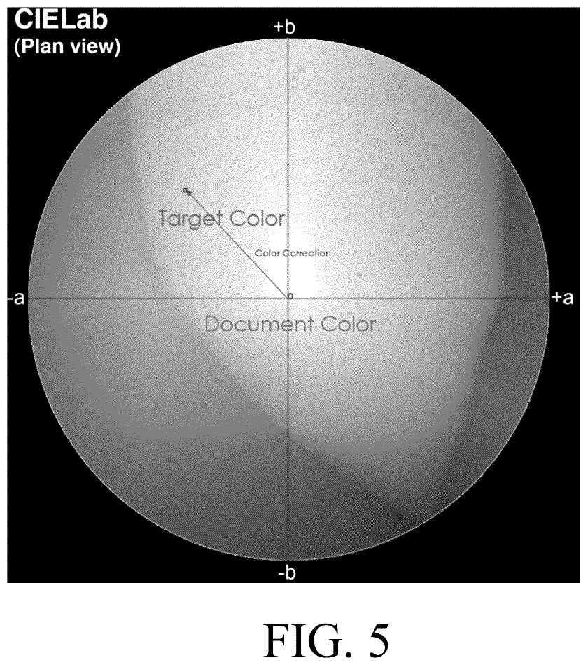

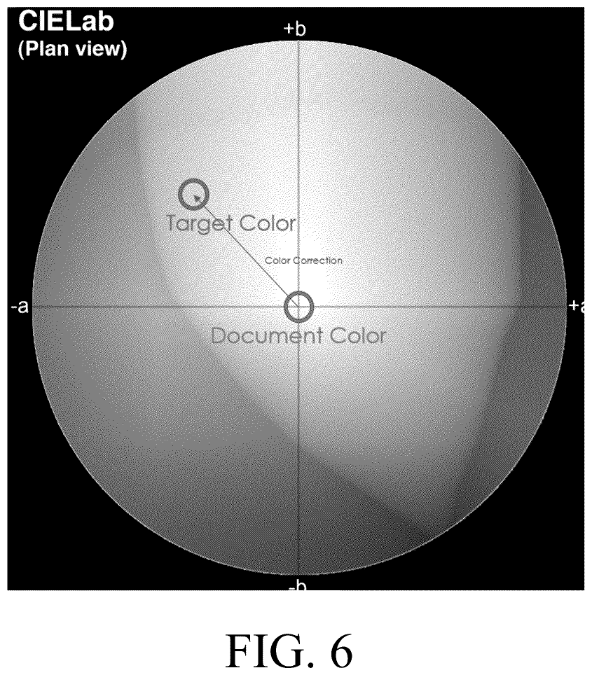

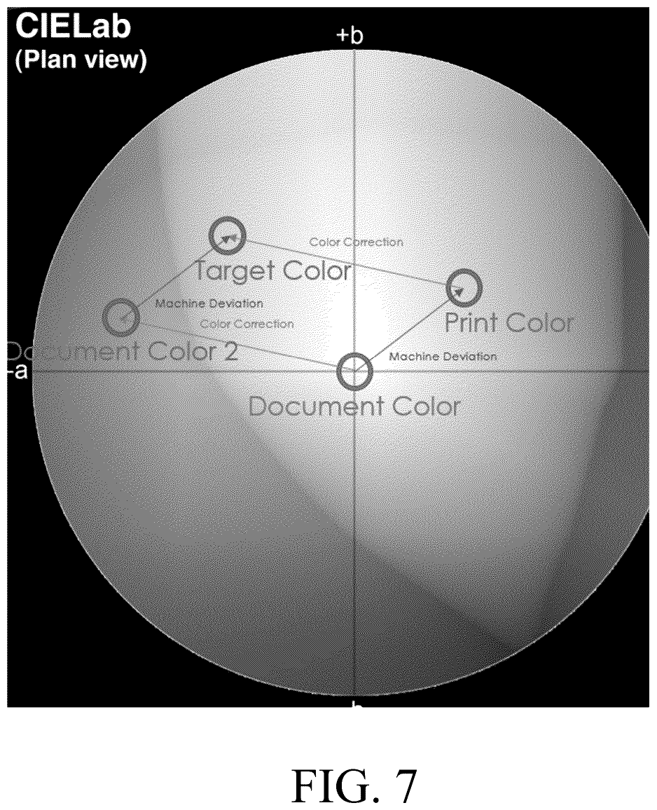

At 414, a color transformation function (or correction) is determined for each source color to target color. The transformation function determined for each source to target color is applied to colors within the radius of each corresponding source color. For example, a single point source color to target color correction is shown in FIG. 5. Further, a transformation of source color with a radius is shown in FIG. 6. In addition to the source color to target color transformation function, a machine deviation transformation (or correction) function can be determined when a machine deviation is determined (e.g., at 412). Accordingly, the color transformation function can include a source to target color transformation with an additional transformation applied for the machine deviation. This transformation is illustrated in FIG. 7. Processing continues to 416.

At 416, a document specific abstract profile is generated based on the color transformation functions determined at 414. Processing continues to 418.

At 418, the document specific abstract profile is applied to the input image file to generate a transformed image file that can be sent for downstream processing (e.g., printing or other downstream processing).

FIG. 5 is a diagram of a single point color transformation in accordance with some implementations.

FIG. 6 is a diagram showing a single point with radius color transformation in accordance with some implementations.

FIG. 7 is a diagram showing a single point with radius color transformation coupled with a machine deviation correction function in accordance with some implementations.

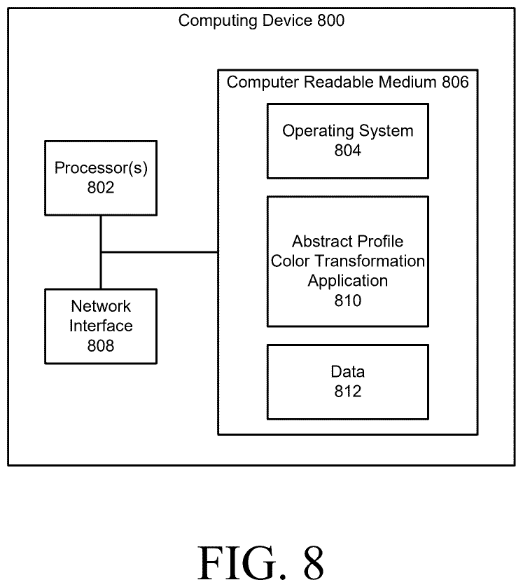

FIG. 8 is a diagram of an example computing device 800 in accordance with at least one implementation. The computing device 800 includes one or more processors 802, nontransitory computer readable medium 806 and network interface 808. The computer readable medium 806 can include an operating system 804, an application 810 for color transformation via document specific abstract profile and a data section 812 (e.g., for storing document specific abstract profiles, etc.).

In operation, the processor 802 may execute the application 810 stored in the computer readable medium 806. The application 810 can include software instructions that, when executed by the processor, cause the processor to perform operations to perform color transformation via document specific abstract profile in accordance with the present disclosure (e.g., performing associated functions described above and shown in FIGS. 2-4).

The application program 810 can operate in conjunction with the data section 812 and the operating system 804.

It will be appreciated that the modules, processes, systems, and sections described above can be implemented in hardware, hardware programmed by software, software instructions stored on a nontransitory computer readable medium or a combination of the above. A system as described above, for example, can include a processor configured to execute a sequence of programmed instructions stored on a nontransitory computer readable medium. For example, the processor can include, but not be limited to, a personal computer or workstation or other such computing system that includes a processor, microprocessor, microcontroller device, or is comprised of control logic including integrated circuits such as, for example, an Application Specific Integrated Circuit (ASIC). The instructions can be compiled from source code instructions provided in accordance with a programming language such as Java, C, C++, C#.net, assembly or the like. The instructions can also comprise code and data objects provided in accordance with, for example, the Visual Basic™ language, or another structured or object-oriented programming language. The sequence of programmed instructions, or programmable logic device configuration software, and data associated therewith can be stored in a nontransitory computer-readable medium such as a computer memory or storage device which may be any suitable memory apparatus, such as, but not limited to ROM, PROM, EEPROM, RAM, flash memory, disk drive and the like.

Furthermore, the modules, processes systems, and sections can be implemented as a single processor or as a distributed processor. Further, it should be appreciated that the steps mentioned above may be performed on a single or distributed processor (single and/or multi-core, or cloud computing system). Also, the processes, system components, modules, and sub-modules described in the various figures of and for embodiments above may be distributed across multiple computers or systems or may be co-located in a single processor or system. Example structural embodiment alternatives suitable for implementing the modules, sections, systems, means, or processes described herein are provided below.

The modules, processors or systems described above can be implemented as a programmed general purpose computer, an electronic device programmed with microcode, a hard-wired analog logic circuit, software stored on a computer-readable medium or signal, an optical computing device, a networked system of electronic and/or optical devices, a special purpose computing device, an integrated circuit device, a semiconductor chip, and/or a software module or object stored on a computer-readable medium or signal, for example.

Embodiments of the method and system (or their sub-components or modules), may be implemented on a general-purpose computer, a special-purpose computer, a programmed microprocessor or microcontroller and peripheral integrated circuit element, an ASIC or other integrated circuit, a digital signal processor, a hardwired electronic or logic circuit such as a discrete element circuit, a programmed logic circuit such as a PLD, PLA, FPGA, PAL, or the like. In general, any processor capable of implementing the functions or steps described herein can be used to implement embodiments of the method, system, or a computer program product (software program stored on a nontransitory computer readable medium).

Furthermore, embodiments of the disclosed method, system, and computer program product (or software instructions stored on a nontransitory computer readable medium) may be readily implemented, fully or partially, in software using, for example, object or object-oriented software development environments that provide portable source code that can be used on a variety of computer platforms. Alternatively, embodiments of the disclosed method, system, and computer program product can be implemented partially or fully in hardware using, for example, standard logic circuits or a VLSI design. Other hardware or software can be used to implement embodiments depending on the speed and/or efficiency requirements of the systems, the particular function, and/or particular software or hardware system, microprocessor, or microcomputer being utilized. Embodiments of the method, system, and computer program product can be implemented in hardware and/or software using any known or later developed systems or structures, devices and/or software by those of ordinary skill in the applicable art from the function description provided herein and with a general basic knowledge of the software engineering and computer networking arts.

Moreover, embodiments of the disclosed method, system, and computer readable media (or computer program product) can be implemented in software executed on a programmed general purpose computer, a special purpose computer, a microprocessor, a network server or switch, or the like.

It is, therefore, apparent that there is provided, in accordance with the various embodiments disclosed herein, methods, systems and computer readable media to perform color transformation via document specific abstract profile.

While the disclosed subject matter has been described in conjunction with a number of embodiments, it is evident that many alternatives, modifications and variations would be, or are, apparent to those of ordinary skill in the applicable arts. Accordingly, Applicants intend to embrace all such alternatives, modifications, equivalents and variations that are within the spirit and scope of the disclosed subject matter.

What is claimed is:

1. A method comprising:
obtaining an input image file having one or more colors in a first color space;
inspecting colors in the input image file to obtain colors in a second color space;
receiving selection of a first source color in the second color space based on a pixel location in the input image file;
receiving a selection of a first source radius in the input image file, wherein the source radius is determined based on the pixel location of the first source color selection;
receiving a first target color in the second color space;
determining a color transformation function from the first source color to the first target color in the second color space;
generating an abstract profile specific to the input image file, wherein the abstract profile includes a color transformation from the first source color to the target color generated by applying the color transformation function and from any additional source colors within the first source radius to respective transformed colors by applying the transformation function to the additional source colors respectively; and
generating an output image file by applying the abstract profile to the input image file to obtain an output image file having transformed colors, wherein the output image file is generated solely with the abstract profile specific to the input image file and without performing an image editing operation on the input image file.

2. The method of claim 1, further comprising:
receiving an output color from an output device as the target color; and
determining a machine deviation transformation function based on the source color and the output color,
wherein generating the abstract profile further includes applying the machine deviation transformation function to the input color in addition to the color transformation function such that the source color and any additional source colors are transformed by applying both the color transformation function and the machine deviation transformation function.

3. The method of claim 1, further comprising:
receiving selection of one or more subsequent source colors and corresponding radii;
generating corresponding color transformation functions for each of the one or more subsequent colors and corresponding additional subsequent colors within the corresponding radius;
receiving one or more subsequent target colors each corresponding to one of the one or more subsequent source colors;
determining one or more subsequent color transformation functions for each of the one or more subsequent source colors,
wherein generating the abstract profile includes one or more subsequent color transformations based on the one or more subsequent color transformation functions.

4. The method of claim 1, further comprising generating printer instructions by applying the abstract profile to the input image file to obtain an output image having transformed colors and being configured to send directly to a printer.

5. The method of claim 1, wherein the first color space is an Lab color space and the second color space is an Lab color space.

6. The method of claim 1, wherein the second color space is an Lab color space and the first color space is a color space different than Lab.
